(19) United States
(12) Patent Application Publication
(10) Pub. No.: US 2010/0151220 A1
(43) Pub. Date: Jun. 17, 2010

(54) Impact Absorbing Product

(76) Inventors: Alan Edward Bowmar, Upper Hutt (NZ); John Geoffrey Bowmar, Upper Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/531,158

(22) PCT Filed: Mar. 13, 2007
(86) PCT No.: PCT/NZ2007/000048

§ 371 Date: Feb. 26, 2010

(51) Int. Cl. B32B 5/00; B32B 9/04; B32B 27/40; B05D 3/02

(52) U.S. Cl. 428/220; 428/411.1; 428/423.1; 427/393.5

(57) ABSTRACT

An impact absorbing product has a continuous phase (9) containing a plurality of microspheres (11) and a polymer covering layer (13) extending over the continuous phase. The continuous phase (9), the microspheres (11) and the covering layer (13) are arranged to absorb energy from an impact sustained if a human falls on the product. A method for manufacturing an impact absorbing product comprises providing a covering layer composition and introducing the covering layer composition onto a support surface (105). A continuous phase composition is introduced onto the covering layer (13). Alternatively, the continuous phase composition is introduced onto the support surface and the covering layer is introduced to the continuous phase. The continuous phase composition is allowed to react to set the reacting mixture and simultaneously expand the microspheres (11).

### FIELD OF THE INVENTION

The invention relates to an impact absorbing product adapted to overlie a walking surface. In particular, the invention relates to an impact absorbing product that remains relatively rigid during normal use and reduces the impact sustained during a fall.

### BACKGROUND

Falls are a major cause of injury, especially among the elderly. Fractured hips, wrists, and vertebrae are common injuries that result from a person falling and hitting a hard surface. In the United States, there were 280,000 hip fractures in 2004 which cost several billion dollars to the healthcare system.

There are various known systems to reduce the risk of injury resulting from falls. It is known to provide devices that are worn on specific areas of the body, such as the hip, to absorb the impact or shock from a fall and reduce the risk of a fracture. However, such devices will protect only the area of the body that is covered. Other body parts, such as wrists, remain uncovered and are not protected from impact during a fall. Additionally, such a device is only useful if a person actually remembers to wear the device.

Products for various purposes are described in U.S. Pat. No. 5,542,221; JP 2003147949; U.S. Pat. No. 4,694,627; U.S. Pat. No. 3,636,577; U.S. Pat. No. 6,235,801; U.S. Pat. No. 6,027,674 U.S. Pat. No. 6,498,198; and WO 98/45359.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is an object of at least preferred embodiments of the present invention to provide a product that will remain relatively rigid under normal use and absorb impact sustained during a fall, and/or to at least provide the public with a useful alternative.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

### SUMMARY OF THE INVENTION

In a first aspect, the invention broadly consists in an impact absorbing product adapted to overlie a walking surface, comprising:
a continuous phase containing a plurality of microspheres; and
a polymer covering layer extending over the continuous phase, with the continuous phase, the microspheres and the covering layer arranged to absorb energy from an impact sustained if a human falls on the product.

A microsphere is a small shell (generally of a polymeric material) encapsulating a gas. It will be appreciated that the shape of the microsphere need not be spherical, although the shape would be substantially spherical.

The term “comprising” as used in this specification means “consisting at least in part of”; that is to say when interpreting statements in this specification which include “comprising”, the features prefaced by this term in each statement all need to be present but other features can also be present. Related terms such as “comprise” and “comprised” are to be interpreted in a similar manner.

Preferably, the polymer covering layer comprises a polyurea, polyurethane, or a combination of polyurea and polyurethane.

Preferably, the microspheres are microspheres that have been expanded as part of a manufacturing process for the product. More preferably, the expanded microspheres are heat-expanded microspheres.

Preferably, the continuous phase comprises an elastomeric continuous phase. More preferably, the elastomeric continuous phase comprises polyurethane. The polyurethane continuous phase may comprise the product of reaction of at least one diisocyanate and at least one polyol, the diisocyanate being a diisocyanate, modified diisocyanate, or a combination of diisocyanate and modified diisocyanate.

Preferably, the microspheres are substantially homogeneously distributed throughout the continuous phase.

Preferably, the ratio of the microspheres to the continuous phase is about 5% to about 15% by weight.

Preferably, a majority of the microspheres have a diameter from less than about 250 microns, more preferably about 20 microns to about 155 microns, more preferably, from about 34 microns to about 55 microns.

Preferably, the polyurea of the covering layer comprises the product of reaction of at least one diisocyanate and at least one polyetheramine, and the polyurethane of the covering layer comprises the product of reaction of at least one diisocyanate and at least one polyol, the diisocyanate being a diisocyanate, modified diisocyanate, or a combination of diisocyanate and modified diisocyanate.

The diisocyanate may be aliphatic or aromatic.

Preferably, the continuous phase containing the microspheres has a hardness of about 10 to about 45, more preferably 20, as measured on the Shore A hardness scale according to ASTM D2240-05.

Preferably, the continuous phase containing the microspheres has a resilience of about 10 to about 35%, more preferably 20%, according to AS2282.11-1999.

Preferably, the covering layer has a hardness in the range of about 50 to about 95, more preferably in the range of about 85 to about 95, as measured on the Shore A hardness scale according to ASTM D2240-05.

Preferably, the covering layer has a tensile strength in the range of about 2400 to about 4200 psi (about 16,500 to about 29,000 kPa), more preferably in the range of about 2900 to about 3500 psi (about 20,000 to about 24,00 kPa), according to ASTM D412-98a-C.

Preferably, the covering layer has an elongation in the range of about 300% to about 600%, more preferably in the range of about 400% to about 500%, according to ASTM D412-98a-C.

Preferably, the covering layer has a tear resistance in the range of about 200 to about 450 pli (about 35,000 to about 79,000 kN/m), more preferably in the range of about 275 to about 375 pli (48,200+/−65,800 kN/m), according to ASTM D624-00-C.

Preferably, the product is formed with an upper surface, a lower surface supportable by the walking surface, and the covering layer forms at least the upper surface of the product. More preferably, the product is formed with sides and the covering layer forms at least the sides of the product.

Preferably, the hardness of the product measured from the upper surface is in the range of about 50 to about 90, as measured on the Shore A hardness scale according to ASTM D2240-05.

Preferably, the hardness of the product measured from the lower surface is in the range of about 10 to about 45, more preferably 20, as measured on the Shore A hardness scale according to ASTM D2240-05.

Preferably, the resilience of the product measured from the upper surface is in the range of about 20% to about 45%, preferably 30%, according to AS2282.11-1999.

Preferably, the resilience of the product measured from the lower surface is in the range of about 10 to about 35%, preferably 20%, according to AS2282.11-1999.

Preferably, the product is formed as a tile or sheet.

The product is suitably adapted to absorb impact from an adult human falling on the product. Alternatively, the product may be adapted to absorb impact from a child human falling on the product. That can be achieved by varying the ratio of microspheres to continuous phase, the size of the microspheres when expanded, and/or the mechanical properties of the continuous phase, for example.

Preferably, the product has an overall depth of about 6 mm to about 15 mm. Most preferably, the product has an overall depth of about 8 mm to about 12 mm, preferably 12 mm.

Preferably, the vertical depth of the covering layer is about 1 mm to about 3 mm.

The product may be an uncovered mat for placing on an existing surface in an area where a fall is likely to occur; for example on a floor surface beside a bed, chair, table, shower, or bath. In at least some embodiments, the product may be suitable for use in outdoor environments, such as under or around children's playground equipment for example. When used in outdoor environments, the product may be a tile. Alternatively, the product may be an underlay for use under other floor covering products, such as carpet or linoleum for example. Again, the underlay could be positioned in an area where a fall is likely to occur, or could be used throughout a room. For indoor use, the product is preferably in tile or sheet form.

In a second aspect, the invention broadly consists in an impact absorbing product adapted to overlie a walking surface, comprising:
a continuous phase containing a plurality of microspheres; and
a covering layer of polyurea, polyurethane, or a combination of polyurea and polyurethane extending over the continuous phase, with the continuous phase, the microspheres and the covering layer arranged to absorb energy from an impact sustained if a human falls on the
   product.

The second aspect may include any of the features outlined in the first aspect above.

In a third aspect, the invention broadly consists in a method for manufacturing an impact absorbing product adapted to overlie a walking surface, comprising:
(a) providing a covering layer composition;
(b) introducing the covering layer composition onto a support surface;
(c) providing a continuous phase composition comprising a continuous phase reacting mixture and a plurality of microspheres;
(d) introducing the continuous phase composition onto the covering layer; and
(e) allowing the continuous phase composition to react to set the reacting mixture and simultaneously expand the microspheres.

In a fourth aspect, the invention broadly consists in a method for manufacturing an impact absorbing product adapted to overlie a walking surface, comprising:
(a) providing a continuous phase composition comprising a reacting mixture and a plurality of microspheres;
(b) introducing the continuous phase composition onto a support surface;
(c) allowing the continuous phase composition to react to set the reacting mixture and simultaneously expand the microspheres;
(d) providing a covering layer composition; and
(e) introducing the covering layer composition onto the continuous phase.

The support surface may be part of a mould cavity. Alternatively, the support surface may be a conveyor belt or similar. A conveyor belt could be used to provide a continuous forming process. The continuous phase prepolymer could initially be held by one or more rollers, and the roller(s) could be passed over the support surface.

Preferably, the covering layer composition comprises a polymer covering layer reacting mixture. More preferably, the polymer covering layer reacting mixture comprises a polyurea reacting mixture, a polyurethane reacting mixture, or a combination of a polyurea reacting mixture and polyurethane reacting mixture.

Alternatively, the covering layer composition comprises a polymer formed as a sheet.

Preferably, the microspheres are unexpanded heat-expandable microspheres and the method comprises heating the continuous phase composition to expand the microspheres.

Preferably, the heating of the continuous phase composition results from an exothermic reaction.

Alternatively or additionally, the heating of the continuous phase composition is carried out by applying an external heat source.

Preferably, the heating of the continuous phase composition is carried out at a temperature in the range of about 80° C. to about 200° C., more preferably, in the range of about 90° C. to about 140° C.

Preferably, the continuous phase reacting mixture comprises at least one polyol and at least one diisocyanate, the diisocyanate being a diisocyanate, modified diisocyanate, or a combination of diisocyanate and modified diisocyanate.

Preferably, the ratio of polyol to unexpanded microspheres is from about 100:5 to about 100:25.

Preferably, the ratio of polyol to diisocyanate is from about 100:25 to about 100:45.

Preferably, the covering layer reacting mixture comprises at least one diisocyanate and at least one polyetheramine to form a polyurea and/or a diisocyanate and a polyol to form a polyurethane, the diisocyanate being a diisocyanate, modified diisocyanate, or a combination of diisocyanate and modified diisocyanate.

The diisocyanate may be aliphatic or aromatic.

Preferably, at least a majority of the microspheres have a diameter from about 6 microns to about 45 microns, more preferably from about 10 microns to about 16 microns, when unexpanded.

Preferably, at least a majority of the microspheres have a diameter less than about 250 microns, more preferably from about 20 microns to about 155 microns, more preferably from about 34 microns to about 55 microns, when expanded.

The method may be manual, semi-automated, or automated.

The product may be formed in sheets on a continuous line or into tiles by discrete moulds.

The third and fourth aspects may include any of the features outlined in the first or second aspect above.

In a fifth aspect, the invention broadly consists in a method for manufacturing an impact absorbing product adapted to overlie a walking surface comprising:
(a) providing a covering layer composition comprising a polyurea reacting mixture, a polyurethane reacting mixture, or a combination of a polyurea reacting mixture and polyurethane reacting mixture;
(b) introducing the covering layer composition onto a support surface;
(c) allowing the covering layer composition to react to form a covering layer;
(d) providing a continuous phase composition comprising a continuous phase reading mixture and a plurality of microspheres;
(e) introducing the continuous phase composition onto the covering layer; and
(f) allowing the continuous phase composition to react to set the reacting mixture and simultaneously expand the microspheres.

In a sixth aspect, the invention broadly consists in a method for manufacturing an impact absorbing product adapted to overlie a walking surface comprising the steps of
(a) providing a continuous phase composition comprising a reacting mixture and a plurality of microspheres;
(b) introducing the continuous phase composition onto a support surface;
(c) allowing the continuous phase composition to react to set the reacting mixture and simultaneously expand the microspheres;
(d) providing a covering layer composition comprising a polyurea reacting mixture, a polyurethane reacting mixture, or a combination of a polyurea reacting mixture and polyurethane reacting mixture;
(e) introducing the covering layer composition onto the continuous phase; and
(f) allowing the covering layer composition to react to form a covering layer.

The fifth and sixth aspects may include any of the features outlined in the first, second, third or fourth aspect above.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

The present invention will now be described with reference to the accompanying drawings in which:

FIG. 1a shows a schematic cross section of a preferred embodiment of the impact absorbing product;

FIG. 1b shows an enlarged view of detail B showing the expanded microspheres;

FIG. 2 shows a preferred method for manufacturing a preferred embodiment impact absorbing product.

### DETAILED DESCRIPTION OF PREFERRED EMBODIMENT

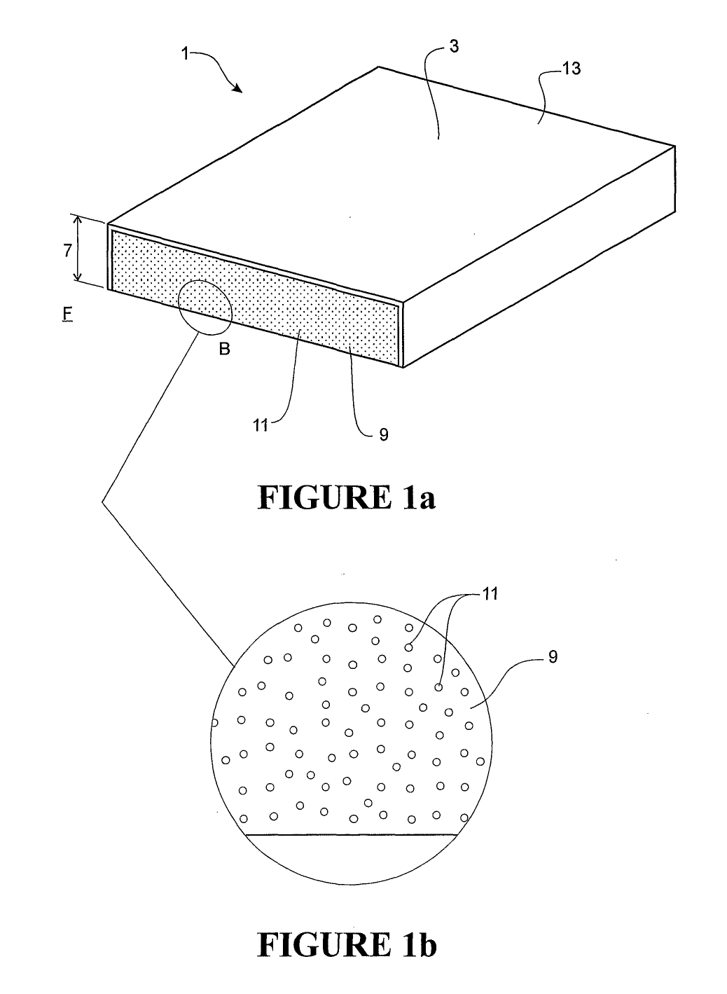

Referring to FIG. 1, a preferred embodiment of an impact absorbing product is shown, indicated generally by reference numeral 1.

The product may be used as an uncovered mat that can be placed in areas where falls are more likely to occur; for example on a floor surface beside a bed, chair, table, shower, or bath. In at least some embodiments, the product may be suitable for use in outdoor environments, such as under or around children's playground equipment for example. When used in outdoor environments, the product may be a tile. Alternatively, the product may be an underlay for use under other floor covering products, such as carpet or linoleum for example. As an underlay, the product may be used domestically or commercially. For example, the product may be used in hospitals or nursing homes, and covet a large part of the floor area of the hospital or nursing home, or at least of selected room(s) thereof. Alternatively, the underlay could be positioned in an area where a fall is likely to occur. The product provides a reduction in impact sustained during falls, while providing sufficient firmness and rigidity during normal use so that the product can be readily walked on.

In the form shown, the product 1 is substantially rectangular in shape and is formed as sheet or mat with an upper surface 3, and a lower surface 5. The product may be formed as a sheet or a tile. The product is adapted to overlie and be supported by a walking surface, which in the form shown is a floor F. However, in at least some embodiments, the product may be suitable for use in outdoor environments, and could be supported by an outdoor ground surface for example. The lower surface 5 rests on the floor F to support the product. The depth 7 of the product preferably ranges from about 6 mm to about 15 mm, more preferably from about 8 mm to about 12 mm. In one preferred embodiment, the depth of the product is about 12 mm. The depth of the mat can be varied depending on the intended use. When used as a mat, the low depth of the mat reduces the risk of the mat becoming a tripping hazard. The risk may be further reduced by providing the mat with sides that taper downwards. The product may have alternative outer shapes.

In a preferred embodiment, the product has a continuous phase 9 of polyurethane containing a plurality of expanded microspheres 11 with a covering layer 13 extending over the continuous phase. The microspheres are suspended in continuous phase and are substantially homogenously dispersed throughout the continuous phase. The ratio of the microspheres to the continuous phase is about 5% to about 15% by weight. In the preferred embodiment, the continuous phase containing the expanded microspheres forms a closed cell, thermoset foam.

In the preferred embodiment, the continuous phase of the impact absorbing product is elastomeric polyurethane. Other materials may be suitable as a continuous phase to contain the microspheres and absorb energy from an impact sustained if a human falls on the product. For example, the continuous phase could be any suitable plastic or rubber elastomeric material.

The polyurethane continuous phase 9 is the product of a reaction between a part A (polyol master batch) and a part B (diisocyanate). The ratio of polyol to diisocyanate is from about 100:25 to about 100:45.

Part A or polyol master batch is a blend of chemicals that contains at least one polyol and the unexpanded microspheres. Part A may additionally contain catalysts and cross linkers. Part A may also include one or more additives such as fire retardants, anti-static agents, anti-bacterial agents, anti-viral agents, colourants or pigments, for example.

The polyols are triols with molecular weights from about 1000 to about 6000. Other suitable polyols could be used, for example diols or quadrols could also be used. In the preferred embodiment the polyol is polyether polyol.

The catalysts may be compounds that contain amine groups. Other suitable, commercially available catalysts that are known to those skilled in the art may be used, for example the catalysts could be tin compounds. The cross-linkers are compounds that contain hydroxyl groups and often include both hydroxyl groups and amine groups. Water may also be a cross-linker. Other suitable, commercially available cross-linkers that are known to those skilled in the art may be used.

The table below lists a typical formulation of part A.

| Name | Parts per hundred polyol |
|---|---|
| Polyol(s) | 100 |
| Catalysts | 1-3 |
| Surfactant | 0-1 |
| Utility agents | 0-3 |
| Cross linking agents | 1-3 |
| Fire retardants | 5-25 |
| Unexpanded microspheres | 5-25 |

Part B contains one or more diisocyanates. The diisocyanate may be a diisocyanate, modified diisocyanate, or combination of diisocyanate and modified diisocyanate. The term “modified diisocyanate” as used herein includes modified polymeric diisocyanates. The diisocyanate or modified diisocyanate could be either aliphatic or aromatic. In the preferred embodiment, the diisocyanate is liquid at room temperature. Alternatively, the diisocyanate may be solid at room temperature. In the preferred embodiment the diisocyanate is a polymeric MDI (methylene diphenyl diisocyanate).

In the preferred embodiment, the microspheres 11 are heat expandable microspheres or microballoons. The unexpanded microspheres consist of a thermoplastic shell encapsulating a blowing agent. When the unexpanded microsphere is heated, the thermoplastic shell softens and at the same time the pressure of the blowing agent increases. This causes the shell to stretch and expand. When the heat is removed, the shell stiffens and the microspheres remain in their new expanded form.

One example of a suitable, commercially available microsphere product is Expancel® produced by Akzo Nobel. The Expancel® microsphere has a thermoplastic shell of a copolymer of some monomers, for example, vinylidene chloride, acrylonitrile and methylmethacrylate, and a blowing agent inside the shell of isobutane or isopentane, for example. The microspheres have a diameter of about 6 microns to about 45 microns in the unexpanded form, preferably about 10 microns to about 16 microns. The microspheres have a diameter less than about 250 microns, for example a diameter of about 20 microns to about 155 microns in the expanded form, preferably about 34 to about 55 microns. In the preferred embodiment, the microspheres are 053 DU 40 from Expancel®, which is a dry unexpanded microsphere product that has a diameter of about 10-16 microns when unexpanded.

Another example of a suitable, commercially available microsphere product is Advancell® produced by SekisuiChemical Co Ltd.

Other suitable, commercially available microsphere products that are known to those skilled in the art could be used.

The polyurethane continuous phase containing the microspheres has the following mechanical properties (values are approximate):

| | | Preferred | |
|---|---|---|---|
| Property | Range | value | Testing Standard |
| resilience | 10% to 35% | 20% | AS 2282.11-1999 |
| density | 400-800 kg/m³ | 475 kg/m³ | AS 2282.3-1999 |
| hardness | 10 to 45 | 20 | Shore A |
| | | | hardness scale |
| | | | ASTM D2240-05 |

The polyurethane continuous phase containing the microspheres is deformable in response to compressive forces. During a fall, the microspheres compress absorbing energy from the impact or shock sustained. The polyurethane continuous phase may absorb energy from direct impact during the fall as well as energy that dissipates from the microspheres.

The covering layer 13 of the preferred embodiment will now be described. The covering layer is a thin layer that extends over the upper surface of the product. The covering layer has a depth of about 1 mm to about 3 mm. In the embodiment shown, the covering layer extends over the upper surface and all four sides of the product. The covering layer may extend over the upper surface only.

The coveting layer 13, together with the expanded microspheres, provides stability and firmness when a person walks on the product. The covering also absorbs energy from impact sustained if a human falls on the product. The covering layer may have a non-slip or frictional top surface to further prevent slips or falls.

The covering layer of the preferred embodiment has the following mechanical properties (values are approximate):

| Property | Range | Preferred value | Testing Standard |
|---|---|---|---|
| Tensile | 2400 to 4200 psi | 3200 +/− 300 psi | ASTM D412-98a-C |
| strength | (16,500 to | (22,000 +/− | |
| | 29,000 kPa) | 2,000 kPa) | |
| Elongation | 300 to 600% | 450 +/− 50% | ASTM D412-98a-C |
| Hardness | 50 to 95 | 90 +/− 5 | Shore A hardness scale |
| | | | ASTM D2240-05 |
| Resistance | 200 to 450 pli | 325 +/− 50 pli | ASTM D624-00-C |
| to tear | (35,000 to | (57,000 +/− | |
| | 79,000 kN/m) | 8,800 kN/m) | |

In the preferred embodiment, the covering layer 13 is a combination of polyurethane and polyurea. In alternative embodiments, the covering layer may be polyurea or polyurethane. Other suitable materials may be used for the covering layer, for example, the covering layer may be a layer of vinyl, polyethylene, ABS or other suitable polymer or combination of polymers, for example. The covering layer could be applied as a thermoplastic sheet or film either on or beneath the continuous phase. An adhesive may be used so that the sheet or film bonds to the continuous phase.

However, polyurea, polyurethane, or a combination of polyurea and polyurethane are preferred as they are easy to work with in liquid form, provide a good bond with the continuous phase, and have similar processing parameters (such as mould temperature and setting times) to the continuous phase.

The covering layer is the product of a reaction between a part A′ (master batch) and part B′ diisocyanate). The Part A′ is a blend of chemicals that contains at least one polyol and at least one polyetheramine to produce a covering layer that is a combination of polyurea and polyurethane. Alternatively, to produce a polyurea cover, part A′ contains at least one polyetheramine. To produce a polyurethane cover, part A′ contains at least one polyol. Part A′ may contains catalysts and cross linkers. Other additives may be added such as fire retardants, anti-static agents, anti-bacterial agents, anti-viral agents, colourants or pigments, for example.

In a preferred embodiment, the polyols have molecular weights from about 1000 to about 6000.

Part B′ contains one or more diisocyanates. The diisocyanate may be a diisocyanate, modified diisocyanate, or combination of diisocyanate and modified diisocyanate. The diisocyanate or modified diisocyanate could be either aliphatic or aromatic.

When parts A′ and B′ are mixed together, the polyetheramine and diisocyanate react to form polyurea and the polyol and diisocyanate react to form polyurethane.

The preferred embodiment has the following mechanical properties (values are approximate):

| | | Preferred | |
|---|---|---|---|
| Property | Range | value | Testing Standard |
| Hardness measured | 50-90 | 70 | Shore A hardness scale |
| from the upper surface | | | ASTM D2240-05 |
| Hardness measured | 10-45 | 20 | Shore A hardness scale |
| from the lower surface | | | ASTM D2240-05 |
| Resilience measured | 20%-45% | 30% | AS 2282.11-1999 |
| from the upper surface | | | |
| Resilience measured | 10-45% | 20% | AS 2282.11-1999 |
| from the lower surface | | | |

During normal use, the expanded microspheres provide firmness and rigidity when a person walks on the product. The microspheres ensure that the product does not compress under normal loads but will compress under typical impact forces sustained when an adult human falls onto the product. An impact force on the product will cause the microspheres to compress and absorb some of the energy from the fall. The energy is distributed from the microspheres and is absorbed by the polyurethane continuous phase. The covering also provides some impact absorption. This reduces the impact on the person's body and consequently reduces the chance of a fracture.

Testing has been carried out on preferred embodiments of the impact absorbing product according to ASTM F355-01-A. This standard relates to a test method for shock absorbing properties of playing surface systems and materials compared to a blank concrete pad. The average results from the testing are shown below. The percentages given are the reduction in peak force compared to the material listed in the left column.

| Comparison material | Percentage reduction in peak force |
|---|---|
| Bare concrete | about 65% to about 80% |
| Bare wood | about 65% to about 80% |
| Carpet and underlay over concrete | about 20% to about 40% |
| Carpet and underlay over wood | about 20% to about 40% |

Testing has been carried out on preferred embodiments of the impact absorbing product according to a number of standardised tests. The test carried out and the results are outlined below.

### HSSC Test E, PT2T1/14 Test Method for Permeability.

No dye penetrated through the backing of the product samples.

### BS 2823:1982 Resistance of Fabrics to Penetration by Water (Hydrostatic Head Test).

The water pressure reached the maximum of 2 metres with no water penetration.

### BS EN 986 2005 Determination of The Dimensional Changes Due to The Effects of Varied Water and Heat Conditions and Distortion Out of Plane.

No change after 48 hours in direction of manufacture and right angles, no curling of edges.

### AS/NZS 2111.2 Determination of Thickness Loss Under Dynamic Loading of Textile Floor Coverings.

| | |
|---|---|
| Percentage thickness loss: | 0.17% |
| Percentage thickness loss after exposure to 500 W UV | 0.15% |
| lamp for 500 hours: | |

### As 4288:2003 Soft Underlays for Textile Floor Coverings

| Change in thickness after dynamic loading at 2 kPa: | 0.00 mm |
|---|---|
| Change in thickness after dynamic loading at 100 kPa: | 0.01 mm |
| Percentage retention of original work of compression: | 100.07% |
| After exposure to 500 W UV lamp for 500 hours: | |
| Change in thickness after dynamic loading at 2 kPa: | 0.01 mm |
| Change in thickness after dynamic loading at 100 kPa: | 0.00 mm |
| Percentage retention of original work of compression: | 99.76% |

### ISO 9073-3 1989 Determination of Breaking Force and Extension.

| Warp breaking force: | 229.4 N |
|---|---|
| Warp percentage extension at 40 N: | 4.0% |
| Weft breaking force: | 224.0 N |
| Weft percentage extension at 40 N: | 3.2% |

AS2111.14: Determination of Thickness Loss after Prolonged Heavy Static Loading of Textile Floor Coverings

| | |
|---|---|
| After 2 minutes recovery: | 0.18% loss |
| After 60 minutes recovery: | 0.15% loss |
| After 24 hours: | 0.00% loss |

### AS/NZ2111.16-1996 Determination of Bond Strength Between Backing Components of a Textile Floor Covering

Testing on the preferred embodiment could not delaminate the covering surface from the polyurethane continuous phase. The foam broke rather than delaminating from the covering layer.

### Method of Manufacture

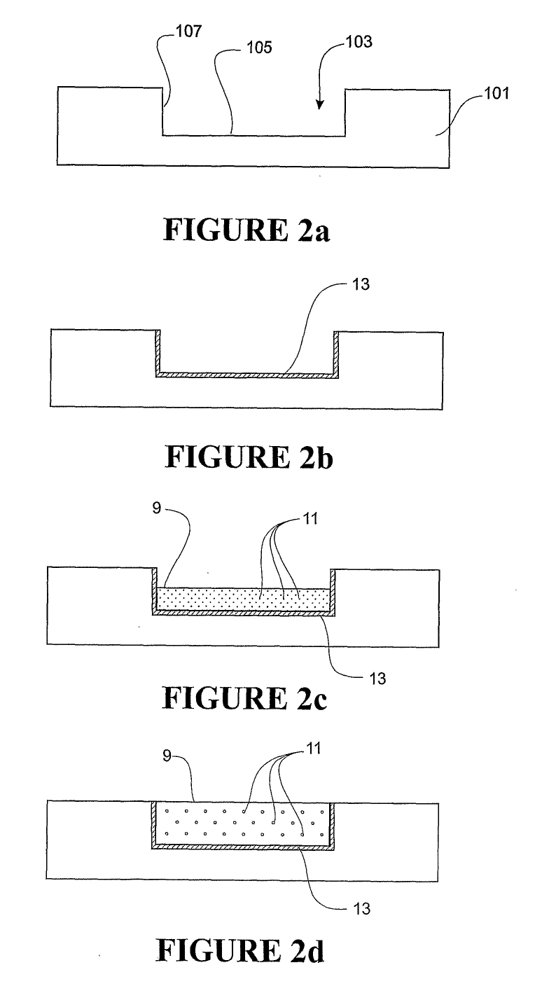

A suitable method of manufacturing the impact absorbing product will now be described, with reference to FIGS. 2a to 2d. The impact absorbing product is manufactured in a mould 101 that includes a cavity 103 with a base 105 and sides 107. The base provides a support surface. The support surface may have a textured surface that forms a corresponding textured surface on the covering layer of the product. The textured surface on the covering layer provides a non-slip surface. Alternatively, the texture could be applied after forming the product, for example by abrasion or force and heat deformation.

The mould may be an open mould with a base part having a cavity, or a closed mould with a base part, a top part, and a cavity formed between the base and top parts.

A covering layer reacting mixture is formed by mixing parts A′ and B′ described above. In the preferred method, Parts A′ and B′ are mixed to form the reacting mixture before moulding. In an alternative embodiment, part B′ may be added to part A′ in the mould.

In a preferred embodiment, the covering layer reacting mixture is a liquid that is sprayed, poured, or coated onto the mould base 105 and walls 107, as shown in FIG. 2b. The covering layer reacting mixture is allowed to react to form a covering layer 13 of a suitable depth. In an alternative embodiment, a sheet or film of a suitable polymer may be placed in the mould to form the covering layer. The sheet or film may be placed in the bottom or top of the mould. An adhesive or glue may be used to encourage the sheet or film to bond with the continuous phase.

A continuous phase reacting mixture is introduced onto the covering layer. The continuous phase layer reacting mixture is formed by mixing parts A and B described above. The reacting mixture is sprayed, poured or injected into the mould 101, such that it partially fills the remaining cavity, as shown in FIG. 2c. The continuous phase reacting mixture is allowed to react to form a polyurethane continuous phase 9.

In the preferred embodiment, the reaction between parts A and B is exothermic. The exothermic reaction provides a heat source that heats the microspheres 11. When the thermoplastic shell of the microsphere is heated, it softens and at the same time the pressure of the blowing agent increases. This causes the shell to stretch and expand. When the heat is removed, the shell stiffens and the microspheres remain in their new expanded form. When expanded, the microspheres have a diameter less than about 250 microns, for example a diameter of about 20 microns to about 155 microns depending on the type of microspheres used. In the preferred embodiment, the expanded microspheres have a diameter of about 34 microns to about 55 microns. Alternatively or additionally, the reacting mixture may be heated by an external heat source, for example by providing heating elements in or near the mould.

The microspheres are heated at a temperature from about 80° C. to about 200° C., either by the exothermic polymerisation reaction or the external heat source. In the preferred method, the microspheres are heated at a temperature of about 90 to about 100° C. Heating causes the microspheres to expand their volume by about 40 times, which corresponds to an increase in diameter of about 3.4 times.

As the microspheres expand, the polyurethane continuous phase 9 expands to fill the cavity, as shown in FIG. 2d. As the polyurethane sets, the chemical reactions cease. The shells of the microspheres cool and are set to the expanded permanent size. The microspheres are evenly dispersed throughout the polyurethane, as shown in FIG. 2d. Prior to mixing with part B, part A is continuously agitated to ensure uniform distribution of the microspheres. After curing, the product is ejected or removed from the mould cavity.

The method described above produces a bond between the covering layer 13 and the polyurethane continuous phase 9. This is shown in the delamination testing results, in which the polyurethane continuous phase and the covering layer could not be delaminated.

Any one or more of the steps of the manufacturing described above may be manual, automated, or semi-automated.

Preferred embodiments of the invention have been described by way of example only and modifications may be made thereto without departing from the scope of the invention.

For example, the product is suitably adapted to absorb impact from an adult human falling on the product. Alternatively, the product may be adapted to absorb impact from a child human falling on the product. That can be achieved by varying the ratio of microspheres to continuous phase, the size of the microspheres when expanded, and/or the mechanical properties of the continuous phase, for example.

In the method described above, the microspheres are added as a component of part A in an unexpanded form then subsequently heated. Alternatively, the microspheres may be added as a component of part A in an expanded form. The microspheres may be added to part B, although this is not the preferred method as any water with the microspheres may react with the diisocyanate.

In the method described above, the covering layer reacting mixture is sprayed into the mould cavity before the continuous phase reacting mixture is introduced into the cavity. Alternatively, the covering layer reacting mixture may be sprayed or coated over the continuous phase after the continuous phase has been moulded and removed from the mould.

In the method described above, the support surface is the base of a mould cavity. Alternatively, the support surface may be a conveyor belt or similar. A conveyor could be used to provide a continuous forming process. The continuous phase prepolymer could initially be held by one or more rollers, and the rollers) could be passed over the support surface.

In the method described above, a covering layer reacting mixture is sprayed into the mould cavity. Alternatively, a sheet or film of a polymer material may be positioned in the mould before the continuous phase reacting mixture is introduced into the cavity. The sheet or film may be placed on a suitable support surface, for example the lower or upper surface of a mould cavity or conveyor belt. The sheet or film may be any suitable polymer such as polyurethane, vinyl, polyethylene, ABS, or other suitable polymer or combination of polymers, for example.

### Standards

Reference has been made herein to various Australian and United States standards. The testing requirements of those standards are summarised briefly below. The full standards are available from the relevant standards associations such as www.standards.com.au and www.astm.org. For the AS standards, AS xxxx.xx represents the relevant standard, and the following four digits represent the year. For the ASTM standards, ASTM xxxx represents the relevant standard, the following two digits represent the year, and the final letter (if applicable) represents a particular test setup from the respective standard.

### ASTM F355-01-A

Impact tests were conducted using a custom-built drop-test device that consisted of an impact cylinder (mass of 3.5 kg) and spherical base (diameter=0.0045 m). The impact head was covered with one layer of Microlite EVA material. The mass was released from a height of 0.35 m by a mechanical release mechanism and the fall controlled by nearly frictionless guide rails. A PCB piezoelectric accelerometer (0-150 g) was mounted on the top of the impact mass and connected via a bridge amplifier and SCSi card to a Powerlab 20-series (AD instruments) data acquisition/recording system. Signals were sampled at 10 kHz and displayed, stored and analysed using Chart 5.2.1 for Windows software.

### AS2282.11-1999

A suitable apparatus consists of a transparent rigid tube of 40+/−5 mm internal diameter, held in a vertical position through which is dropped a steel ball, of 16+/−0.2 ram diameter and weighing 16.5+/−0.5 g, from a magnet or other device to permit the ball to fall, when released centrally, down the tube without rotation. The height of the tube shall be such as will permit a drop of 500 mm above the surface of the test specimen. The test piece shall be not less than 100 mm×100 mm×50 mm+/−2 mm. The ball is released, and the rebounded height is noted. That is repeated three times, and the mean is calculated.

### AS2282.7-1999

Test pieces 150 mm long, cut to 25 mm thick shall have a cut made 40 mm long in one end. The thickness shall be +/−0.2 mm. Each piece is inserted into the jaws of a testing machine (a power driven machine capable of testing force to an accuracy of 2%, fitted with suitable grips/jaws). The machine is operated until at least 50 mm is torn. The maximum force is recorded.

### AS2282.6-1999

A power driven tensile testing machine is required complying with the following; rate of travel shall be 500+/−50 mm and sensitivity such that the breaking load can be measured to +/−1%.

Cut the test pieces in dumbbell shape—entire length 152 mm, centre narrow section 55 mm, wide ends 25 mm thick and narrow section 13 mm thick. Place the test pieces in the grips of the testing machine. Start the machine, and record the maximum force and the distance between the two edges of two reference lines immediately prior to break of the piece.

### AS2282.3-1999

A test piece will be of a shape so that the volume can be easily calculated.

The test piece will be as large as possible commensurate with the scales available and the shape of the original material. Measure the dimensions in millimetres and weigh the test piece to an accuracy of 0.5% and express the mass in grams. Density=10̂6×m/V, m=mass in grams, and V=volume in cubic millimetres.

### ASTM D624-00-C

A tearing strain (and stress) is applied to a test specimen by means of a tensile testing machine without interruption at a constant rate of crosshead traverse until the specimen is completely torn. The test method measures the force per unit thickness required to rupture, initiate, or propagate a tear.

### ASTM D412-98a-C

The determination of tensile properties starts with test pieces taken from the sample material and includes preparation of the specimens and testing of the specimens. Specimens may be in the shape of dumbbells, rings or straight pieces of uniform cross-sectional area. Tension tests shall be made on a power driven machine equipped to produce a uniform rate of grip separation of 500+/−50 mm/min for a distance of 750 mm.

### ASTM D2240-05

This test method covers twelve types of hardness measurement devices known as durometers: Types A, B, C, D, DO, E, M, O, OO, OOO-S, R. This test method is based upon the penetration of a specific type of indenter when forced into the material under specified conditions.

### HSSC Test E P271/14 Test Method for Impermeability

The test involves dropping dye coloured water onto the sample from 1 metre in height.

### BS 2823:1982 Resistance of Fabrics to Penetration by Water (Hydrostatic Head Test)

This is a hydrostatic head test that measures resistance of fabrics to penetration to water. The principle is the same as the impermeability test, but the water is applied with continuing pressure. The equipment used for testing samples of the preferred product is capable of reaching 2 metres of water, which equates to about 19.6 KPa.

### BSEN 986 2005 Determination of the Dimensional Change Due to the Effect of Varied Water and Heat Distortion Out of Plane

This test measures changes to dimensions after heat and water. This test is usually carried out on floor tiles and is designed to pick up any changes in dimensions after heat and water, as might be expected in wet cleaning. Any floor coverings that change with these conditions will not be satisfactory.

Samples are measured using vernier calipers in the direction of manufacture at right angles. The sample is conditioned and then measured. The sample is then heated for 2 hours at 60+/−2° C. and measured, immersed in water for 2 hours at 20+/−2° C. and measured, dried at 60+/−2° C. for 24 hours and measured, left at room temperature for 48 hours and measured.

### AS NZS2111.2 Determination of Thickness Loss Under Dynamic Loading of Textile Floor Coverings

This is similar in principle to the static loading test, but the load applied is in a cyclic pattern to assimilate a walking action.

### AS 4288:2003 Soft Underlays for Textile Floor Coverings Appendix A

This test is carried out before and after dynamic loading. The work of compression is a method for measuring the thickness and compression characteristics of underlays. It is the area under the curve of the load-deflection curve.

A sample is compressed with 2 kPa pressure and the height is measured. Dynamic loading is applied, then the sample is compressed with 2 kPa pressure and the height is re-measured. The sample is compressed with 10 kPa and the height is measured at 100 kPa, then dynamic loading is applied and height is re-measured at 100 kPa.

Tests after Exposure

As a means of assessing whether the exposure to UV had any influence on the physical characteristics dynamic loading and work of compression were carried out after 500 hours in a 500 Watt MBTF lamp.

### AS/NZ2111.16-1996 Determination of Bond Strength Between Backing Components of a Textile Floor Covering

The test involves cutting strips of samples, partially delaminating them and then measuring the force required to continue.

### ISO 9073-3 Breaking Force and Extension

This measures the tensile strength and extension at break of strips of the sample measured in two directions. There are pass levels in AS/NZS 4288 for both strength and extension.

AS/NZ2111.14-1996 Determination of Thickness Loss after Prolonged, Heavy Static Loading of Textile Floor Coverings

A load of 700 kPa is applied to the sample for 24 hours, allowed to recover without the load for another 24 hours and the % thickness loss is calculated. The thickness is measured using the gauge as in the thickness test.

1. An impact absorbing product adapted to overlie a walking surface, comprising:
a continuous phase containing a plurality of microspheres; and
a polymer covering layer extending over the continuous phase and forming at least an upper surface of the product, with the continuous phase, the microspheres and the covering layer arranged to absorb energy from an impact sustained if a human falls on the product; wherein the hardness of the product measured from the upper surface is in the range of about 50 to about 90, as measured on the Shore A hardness scale according to ASTM D2240-05.

2. An impact absorbing product as claimed in claim 1 wherein the hardness of the product measured from the upper surface is in the range of about 60 to about 90, as measured on the Shore A hardness scale according to ASTM D2240-05.

3. An impact absorbing product as claimed in claim 2 wherein the hardness of the product measured from the upper surface is about 70, as measured on the Shore A hardness scale according to ASTM D2240-05.

4. An impact absorbing product as claimed in claim 1 wherein the polymer covering layer comprises a polyurea, polyurethane, or a combination of polyurea and polyurethane.

5.-7. (canceled)

8. An impact absorbing product as claimed in claim 1 wherein the continuous phase comprises an elastomeric continuous phase.

9. An impact absorbing product as claimed in claim 1 wherein the elastomeric continuous phase comprises polyurethane.

10.-17. (canceled)

18. An impact absorbing product as claimed in claim 1 wherein the continuous phase containing the microspheres has a hardness of about 10 to about 45 as measured on the Shore A hardness scale according to ASTM D2240-05.

19. (canceled)

20. An impact absorbing product as claimed in claim 1 wherein the continuous phase containing the microspheres has a resilience of about 10% to about 35% according to AS2282.11-1999.

21. (canceled)

22. An impact absorbing product as claimed in claim 1 wherein the covering layer has a hardness in the range of about 50 to about 95, as measured on the Shore A hardness scale according to ASTM D2240-05.

23.-31. (canceled)

32. An impact absorbing product as claimed in claim 1 wherein the hardness of the product measured from the lower surface is in the range of about 10 to about 45, as measured on the Shore A hardness scale according to ASTM D2240-05.

33. (canceled)

34. An impact absorbing product as claimed in claim 1 wherein the resilience of the product measured from the upper surface is in the range of about 20% to about 45% according to AS2282.11-1999.

35. (canceled)

36. An impact absorbing product as claimed in claim 1 wherein the resilience of the product measured from the lower surface is in the range of about 10% to about 45% according to AS2282.11-1999.

37. (canceled)

38. An impact absorbing product as claimed in claim 1 wherein the vertical depth of the product is about 6 mm to about 15 mm.

39.-43. (canceled)

44. An impact absorbing product as claimed in claim 1 wherein the product is formed as a tile or sheet.

45. A method for manufacturing an impact absorbing product adapted to overlie a walking surface comprising:
(a) providing a covering layer composition;
(b) introducing the covering layer composition onto a support surface;
(c) providing a continuous phase composition comprising a continuous phase reacting mixture and a plurality of microspheres;
(d) introducing the continuous phase composition onto the covering layer; and
(e) allowing the continuous phase composition to react to set the reacting mixture and simultaneously expand the microspheres;
wherein steps (a) to (e) form an impact absorbing product having an upper surface formed by the covering layer; and
wherein the hardness of the product measured from the upper surface is in the range of about 50 to about 90, as measured on the Shore A hardness scale according to ASTM 02240-05.

46. A method for manufacturing an impact absorbing product adapted to overlie a walking surface comprising:
(a) providing a continuous phase composition comprising a reacting mixture and a plurality of microspheres;
(b) introducing the continuous phase composition onto a support surface;
(c) allowing the continuous phase composition to react to set the reacting mixture and simultaneously expand the microspheres;
(d) providing a covering layer composition; and
(e) introducing the covering layer composition onto the continuous phase;
wherein steps (a) to (e) form an impact absorbing product having an upper surface formed by the covering layer; and
wherein the hardness of the product measured from the upper surface is in the range of about 50 to about 90, as measured on the Shore A hardness scale according to ASTM 02240-05.

47.-48. (canceled)

49. A method as claimed in claim 45 wherein the covering layer composition comprises a polyurea reacting mixture, or a combination of a polyurea reacting mixture and polyurethane reacting mixture.

50. (canceled)

51. A method as claimed in claim 45 wherein the continuous phase composition comprises a polyurethane reacting mixture.

52.-60. (canceled)

61. A method as claimed in claim 45 wherein the microspheres are unexpanded heat-expandable microspheres and the method comprises heating the continuous phase composition to expand the microspheres.

62.-63. (canceled)

64. A method as claimed in claim 61 wherein the heating of the continuous phase composition is carried out at a temperature in the range of about 80° C. to about 200° C.

65.-67. (canceled)

68. An impact absorbing product adapted to overlie a walking surface, comprising:
a continuous phase containing a plurality of microspheres; and
a covering layer of polyurea, or a combination of polyurea and polyurethane, the covering layer extending over the continuous phase, with the continuous phase, the microspheres and the covering layer arranged to absorb energy from an impact sustained if a human falls on the product.

69.-70. (canceled)

71. An impact absorbing product as claimed in claim 68 wherein the continuous phase comprises an elastomeric continuous phase.

72. An impact absorbing product as claimed in claim 68 wherein the elastomeric continuous phase comprises polyurethane.

73. An impact absorbing product as claimed in claim 72 wherein the polyurethane continuous phase comprises the product of reaction of at least one diisocyanate and at least one polyol, the diisocyanate being an diisocyanate, modified diisocyanate, or a combination of diisocyanate and modified diisocyanate.

74. An impact absorbing product as claimed in claim 68 wherein the microspheres are substantially homogeneously distributed throughout the continuous phase.

75.-82. (canceled)

83. An impact absorbing product as claimed in claim 68 wherein the vertical depth of the product is about 6 mm to about 15 mm.

84.-88. (canceled)

89. An impact absorbing product as claimed in claim 68 wherein the product is formed as a tile or sheet.

90. A method for manufacturing an impact absorbing product adapted to overlie a walking surface comprising:
(a) providing a covering layer composition comprising a polyurea reacting mixture, or a combination of a polyurea reacting mixture and polyurethane reacting mixture;
(b) introducing the covering layer composition onto a support surface;
(c) allowing the covering layer composition to react to form a covering layer;
(d) providing a continuous phase composition comprising a continuous phase reacting mixture and a plurality of microspheres;
(e) introducing the continuous phase composition onto the covering layer; and
(f) allowing the continuous phase composition to react to set the reacting mixture and simultaneously expand the microspheres.

91. A method for manufacturing an impact absorbing product adapted to overlie a walking surface comprising the steps of:
(a) providing a continuous phase composition comprising a reacting mixture and a plurality of microspheres;
(b) introducing the continuous phase composition onto a support surface;
(c) allowing the continuous phase composition to react to set the reacting mixture and simultaneously expand the microspheres;
(d) providing a covering layer composition comprising a polyurea reacting mixture, or a combination of a polyurea reacting mixture and polyurethane reacting mixture;
(e) introducing the covering layer composition onto the continuous phase; and allowing the covering layer composition to react to form a covering layer.

92. (canceled)

93. A method as claimed in claim 90 wherein the microspheres are unexpanded heat-expandable microspheres and the method comprises heating the continuous phase composition to expand the microspheres.

94.-108. (canceled)

109. A method as claimed in claim 46 wherein the covering layer composition comprises a polyurea reacting mixture, or a combination of a polyurea reacting mixture and polyurethane reacting mixture.

110. A method as claimed in claim 46 wherein the continuous phase composition comprises a polyurethane reacting mixture.

111. A method as claimed in claim 46 wherein the microspheres are unexpanded heat-expandable microspheres and the method comprises heating the continuous phase composition to expand the microspheres.

112. A method as claimed in claim 111 wherein the heating of the continuous phase composition is carried out at a temperature in the range of about 80° C. to about 200° C.

113. A method as claimed in claim 91 wherein the microspheres are unexpanded heat-expandable microspheres and the method comprises heating the continuous phase composition to expand the microspheres.
